(19) United States
(12) Patent Application Publication
(10) Pub. No.: US 2013/0056599 A1
(43) Pub. Date: Mar. 7, 2013

(54) APPARATUS AND METHOD FOR TOOLLESSLY, RELEASABLY ATTACHING COMPONENTS TO A STRUCTURE

(71) Applicants: Steven Ray Baker, Mission, TX (US); Mark Robert Dagley, Fort Worth, TX (US); Anthony Lynn Williams, Fort Worth, TX (US); Antwan Joco'ques Works, Lewisville, TX (US)

(72) Inventors: Steven Ray Baker, Mission, TX (US); Mark Robert Dagley, Fort Worth, TX (US); Anthony Lynn Williams, Fort Worth, TX (US); Antwan Joco'ques Works, Lewisville, TX (US)

(21) Appl. No.: 13/567,288

(22) Filed: Aug. 6, 2012

Related U.S. Application Data
(60) Provisional application No. 61/530,697, filed on Sep. 2, 2011.

(51) Int. Cl. G02B 7/00; B23P 11/00

(52) U.S. Cl. 248/220.22; 248/309.1; 248/288.11; 29/525.01

(57) ABSTRACT

An apparatus for toollessly, releasably attaching an optical component to a structure is disclosed. The optical component has a snap fastener. The snap fastener may be integrally formed with and part of the optical component. An accepting feature is attached to the structure. When the snap fastener is brought into contact with the accepting feature, the accepting feature accepts the snap fastener thereby toollessly, releasably attaching the optical component to the structure.

### RELATED APPLICATIONS

This application claims the benefit of priority under 35 U.S.C. §119 of U.S. Provisional Application Ser. No. 61/530,697 filed on Sep. 2, 2011 the content of which is relied upon and incorporated herein by reference in its entirety.

### BACKGROUND

1. Field of the Disclosure

The technology of the disclosure relates to optical components and an apparatus and method for toollessly and releasably attaching components to a structure.

2. Technical Background

In the telecom industry, panels and modules serve as connection points, housing fiber optic adapters. Traditional methods for fastening metal panels or modules, even plastic, to an enclosure employ use of fasteners such as plungers and grommets or other types of mechanical fasteners, such as screws or captive fasteners. Fasteners in the panels or modules are used to secure the panel or module to another component by allowing the plunger/grommet system to snap in place. However, traditional methods are designed to support specific types of optical components making configuring or reconfiguring the structure for different optical components impossible or, at least, costly and time consuming.

### SUMMARY OF THE DETAILED DESCRIPTION

Embodiments disclosed herein include an apparatus and method for toollessly and releasably attaching an optical component to a structure. The optical component has a snap fastener. The snap fastener may be integrally formed with and a part of the optical component. An accepting feature is attached to the structure. When the snap fastener is brought into contact with the accepting feature, the accepting feature accepts the snap fastener thereby releasably attaching the optical component to the structure.

In another aspect, embodiments disclosed herein also include a cradle assembly having a cradle adapted to receive an optical component such that the optical component toollessly, releasably attaches to the cradle and a cradle connection assembly, wherein the cradle connection assembly is adapted to toollessly and releasably attach to a housing a snap fastener. The optical component may be a module and/or an adapter panel having fiber optic adapters. Additionally, the optical component may be a slack box. The cradle assembly may include a hinge allowing the cradle to rotate between an unengaged position and an engaged position. A snap fastener may releasably, toollessly attach the cradle in the engaged position.

In another aspect, embodiments disclosed herein also include a method for toollessly and releasably attaching an optical component to a structure. The method includes, providing a snap fastener attached to the optical component, providing an accepting feature attached to the structure, and moving the optical component such that the snap fastener contacts the accepting feature wherein the accepting feature accepts the snap fastener toollessly and releasably attaching the optical component to the structure. The structure may be an enclosure, a housing, or a chassis. Additionally, the structure may be a cradle. The optical component may be a module and/or an adapter panel, each of which may have adapters. Additionally, the optical component may be a slack box

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a perspective, partially exploded view of an exemplary embodiment of a cradle assembly toollessly and releasably attachable using snap fasteners;

FIG. 1A is a partial, bottom, exploded perspective view of a slack box and a cradle of the cradle assembly of FIG. 1 toollessly and releasably attachable using snap fasteners;

FIG. 2 is a view of a module as ready to be inserted into the cradle of the cradle assembly of FIG. 1, with the cradle assembly shown toollessly and releasably attached to an enclosure or housing;

FIG. 3 is a view of the snap fastener in the side flange of an adapter panel for toollessly, releasably attaching the adapter to the cradle assembly of FIG. 1;

FIG. 4A is a side view of the snap fastener to be toollessly and releasably attached to an accepting feature;

FIG. 4B is a side view of the snap fastener of FIG. 4A toollessly and releasably attached to an accepting feature;

FIG. 5 is a front, perspective view of the cradle assembly of FIG. 2 with the module attached to the cradle assembly and the cradle assembly attached to the housing;

FIG. 5A is a partial, perspective detail view of the cradle connection assembly of the cradle assembly of FIG. 1, showing a catch flange extending from a cradle plate;

FIG. 6 is a perspective, rear view of the cradle assembly of FIG. 1 shown between an unrotated, unengaged position and a rotated engaged position;

FIG. 7 is a perspective, rear view of the cradle assembly of FIG. 1 shown in the rotated, engaged position;

FIG. 8A is a top, perspective view of an exemplary embodiment adapter panel that has the snap fastener molded into the panel;

FIG. 8B is a side, perspective view of the adapter panel of FIG. 8A;

FIG. 8C is a bottom, perspective view of the adapter panel of FIG. 8A.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed herein include a snap fastener for toollessly and releasably locking optical components to a structure, for example, without limitation, a housing, enclosure or chassis. The snap fastener may be any type or design of fastener that provides for toolless and releasable locking or attaching of one component to another. Additionally, the snap fastener may be one used for sheet metal as a non-limiting example, a Snap Lock™ fastener. In such a case, the snap fastener functions analogously to plastic snaps but is used for components constructed of sheet metal. Use of the snap fastener in panels and modules eliminates the need for additional fasteners or components to fasten or secure a panel or module within an enclosure. Other components within the enclosure may also employ use of the snap fastener to assemble or disassemble components and may eliminate the need for additional components and the use of tools for installation.

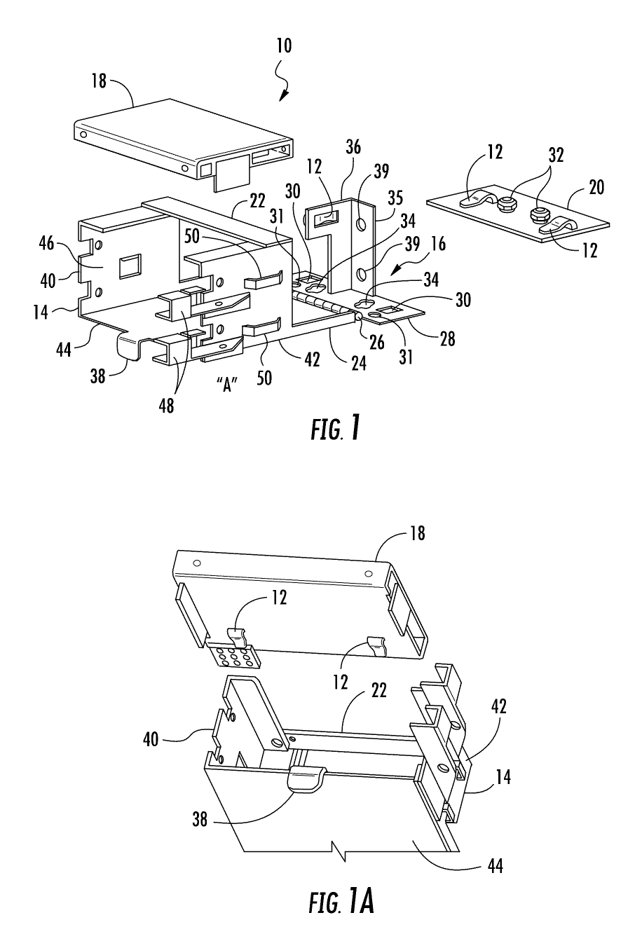

In this regard, FIG. 1 illustrates a cradle assembly 10 that includes snap fasteners 12 to attach the components of the cradle assembly 10 to each other. The cradle assembly 10 includes a cradle 14, a cradle connection assembly 16, a slack box 18 and a housing plate 20. The slack box 18 toollessly and releasably attaches to a cradle bar 22 on the cradle 14 using snap fasteners 12 as shown on FIG. 1A, which illustrates a bottom, exploded, perspective partial detail view of the cradle assembly 10. The slack box 18 may be used for storing fiber optic cable slack. The cradle 14 includes a cradle extension 24 which connects to the cradle connection assembly 16 at hinge 26 providing a rotatable connection between cradle extension 24 and cradle connection assembly 16 allowing the cradle 14 and the cradle connection assembly 16 to rotate about each other. In FIG. 1, the cradle 14 is shown in an un-rotated, unengaged position designated as “A”. The housing plate 20 attaches to a surface of a housing, enclosure or chassis (not shown in FIG. 1). The cradle connection assembly 16 has a cradle plate 28 with two slots 30. The housing plate 20 has two snap fasteners 12. The two snap fasteners 12 may be integral with and a part of the housing plate 20. The cradle connection assembly 16 toollessly, releasably attaches to the housing plate 20 by the housing plate's 20 two snap fasteners 12. The housing plate's 20 two snap fasteners 12 position in the respective slots 30 and holes 31 in a cradle plate 28. The respective slots 30 and holes 31 are accepting features of the cradle plate 28. In this manner, since the housing plate 20 is attached to a surface of the housing and the cradle connection assembly 16 is toollesly and releasably attached to the housing plate 20, due to the hinge 26, the cradle 14 may rotate about the housing plate 20, and, thereby, the housing. This will be discussed in more detail below. As an additional or alternative attachment to the housing, the cradle connection assembly 16 may be attached to the housing plate 20 using security screws 32 inserted into screw holes 34 in the cradle plate 28.

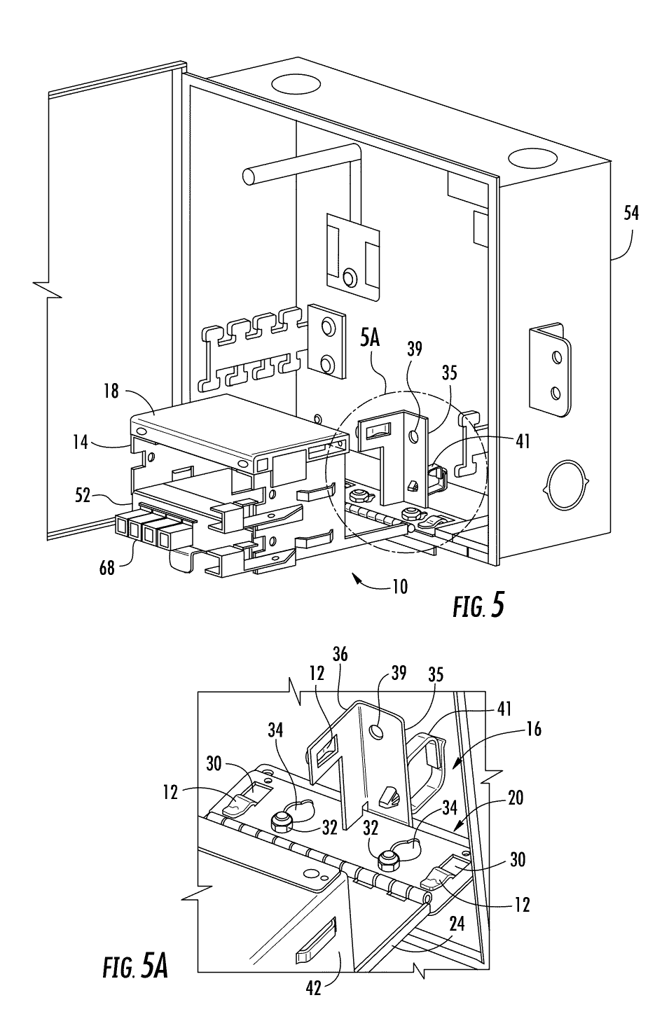

Continuing with reference to FIG. 1, the cradle connection assembly 16 includes a catch flange 35 attached to and extending from the cradle plate 28. As shown in FIG. 1, the catch flange 35 may be a vertically extending right-angled structure with a tab feature 36. The tab feature 36 provides a surface for locating a snap fastener 12 oriented in a direction toward the cradle 14. The snap fastener 12 is positioned such that as the cradle 14 rotates on the hinge 26, the snap fastener 12 engages a mating feature (not visible in FIG. 1) attached to the cradle extension 24. In this manner, the snap fastener 12 may toollessly and releasably lock the cradle 14 in a rotated, engaged position (designated as “B” see FIG. 7) until the cradle 14 is rotated back to the un-rotated position “A”. A finger tab 38 may be used to rotate the cradle 14 between the un-rotated, unengaged position and the rotated, engaged position. Two component mounting holes 39 are shown extending through the catch flange 35. The component mounting holes 39 may be used to mount other components, as a non-limiting example, a routing guide, one of which is illustrated in FIG. 5A.

The cradle 14 has a first side 40, a second side 42 and a bottom 44, which with the slack box 18 toollessly and releasably attached to the cradle bar 22, define an interior 46 of the cradle 14. One or more routing guides 48 may attach to either or both of the first side 40 and the second side 42. Additionally, tie down lances 50 may extend from the first side 40 and/or the second side 42. The routing guides 48 direct optical fibers around the sides 40, 42 of the cradle 14, while the tie down lances 50 may be used for fastening tie wraps, or the like, to restrain the optical fibers. In this way, the optical fibers associated with a module or an adapter panel may be organized and managed.

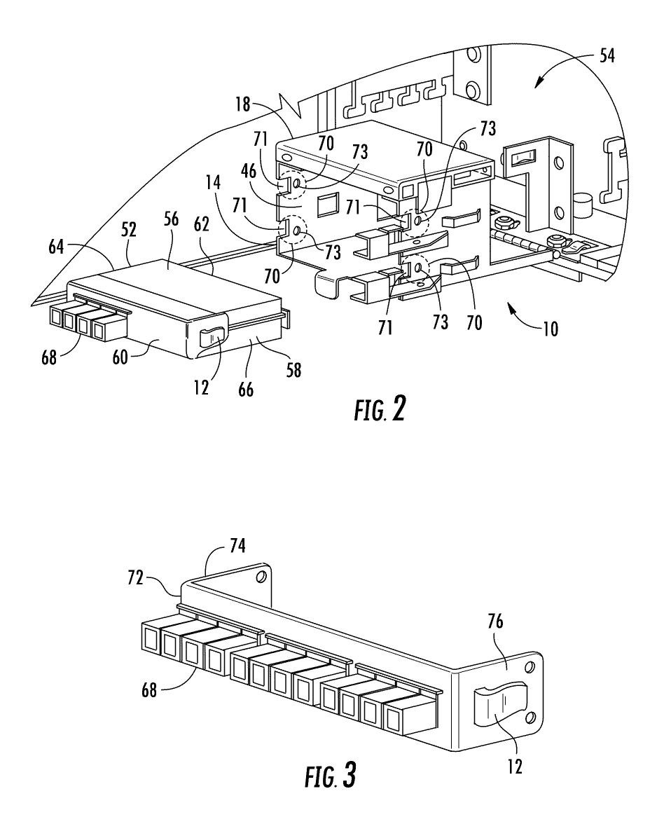

Referring now to FIG. 2 a module 52 positioned to be inserted into the cradle 14 in the un-rotated position is illustrated. The cradle assembly 10 is shown attached to a housing 54. It should be understood that housing 54 is intended to refer to and include any type or design of structure to or on which the cradle assembly 10 may be attached. The module 52 may have a cover 56 and a base 58 with the base 58 having a front 60, a back 62, a first side 64 and a second side 66. In FIG. 2, fiber optic adapters 68 in the form of SC adapters are shown mounted in the front 60. Although SC adapters are shown, it should be understood that any type of fiber optic adapters 68 may be mounted in or on the module 52. The second side 66 has a snap fastener 12. The snap fastener 12 may be integral with and a part of the second side 66. The module 52 may be inserted into the cradle 14 by inserting the back 62 of the module 52 in the interior 46. As the module 52 inserts into the interior 46 of the cradle 14, the second side's 66 snap fastener 12 engages an accepting feature 70 or mating part in the cradle 14 upon installation. In the embodiment shown in FIG. 2, the accepting feature 70 in the cradle 14 may be a rectangular cutout 71 and a snap hole 73. The mating of the snap fastener 12 and the accepting feature 70 toollessly and releasably locks the module 52 in place within the cradle 14.

An adapter panel 72 with adapters 68 mounted thereon may be used with the cradle assembly 10 in the same manner as a module 52. FIG. 3 illustrates an adapter panel 72 with a first side flange 74 and a second side flange 76. The snap fastener 12 in the first and second side flanges 74, 76 of an adapter panel 72 are designed to fit the cradle assembly 10 shown in FIG. 2. The snap fasteners 12 on both first and the second side flanges 74, 76 (as it is in a module) engage the respective accepting feature 70 in the cradle 14 when installed. The snap fasteners 12 may serve as a stopping point as well during installation.

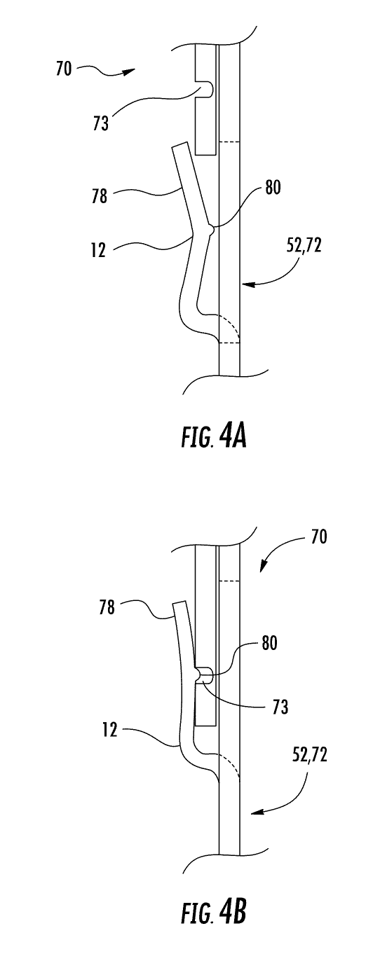

FIGS. 4A and 4B show the snap fastener 12 from a side view to illustrate the construction of the snap fastener 12 and its engagement with the mating part 70. An angled flange 78 acts as a guide or lift causing the snap fastener 12 to spring out when the mating part 70 moves or slides into or on to the snap fastener 12. A barb 80 on the snap fastener 12 positions in the snap hole 73 and holds the panel 72 or module 52 in place. The barb 80 catches a snap hole 73 in the mating part.

FIGS. 5 and 5A illustrate the cradle assembly 10 attached to the housing 54 via use of the snap fasteners 12 attached to the housing plate 20, which is attached to the housing 54. The housing plate 20 is shown as having two snap fasteners 12, but it should be understood that the housing plate 20 may have any number of snap fasteners 12. The cradle assembly 10 may toollessly and releasably connect to the housing 54 via the cradle plate 28 of the cradle connection assembly 16. The cradle plate 28 has two slots 30 each with the hole 31 to accept the respective snap fasteners 12. The cradle assembly 10 may have security screws 32 extending through the screw holes 34 in the cradle plate 28 and into the housing plate 20 to ensure the cradle assembly 10 is fully secure to the housing 54 upon installation and that the cradle assembly 10 does not move once installed and the cradle 14 is in the rotated, engaged position. In FIGS. 5 and 5A, a routing guide 41 is shown positioned in one of the component mounting holes 39.

To install the cradle 14 to the housing 54, the cradle connection assembly 16 is positioned over the housing plate 20 such that the snap fasteners 12 align with the slots 30, and the security screws 32 align with the screw holes 34. The cradle 14 and the cradle connection assembly 16 are then lowered onto the housing plate 20 to allow the snap fasteners 12 to insert into the slots 30 and the security screws 32 to insert into the screw holes 34. The cradle 14 and the cradle connection assembly 16 are moved toward the housing 54 allowing the barb 80 (not shown in FIGS. 5 and 5A) to engage the respective hole 31 in the cradle plate 28. The screw holes 34 move in a manner to position the security screws 32 toward the end of the screw holes 34 where the security screws 32 may be tightened down. A tool, as a non-limiting example, a screw driver, may be used to tighten the security screws.

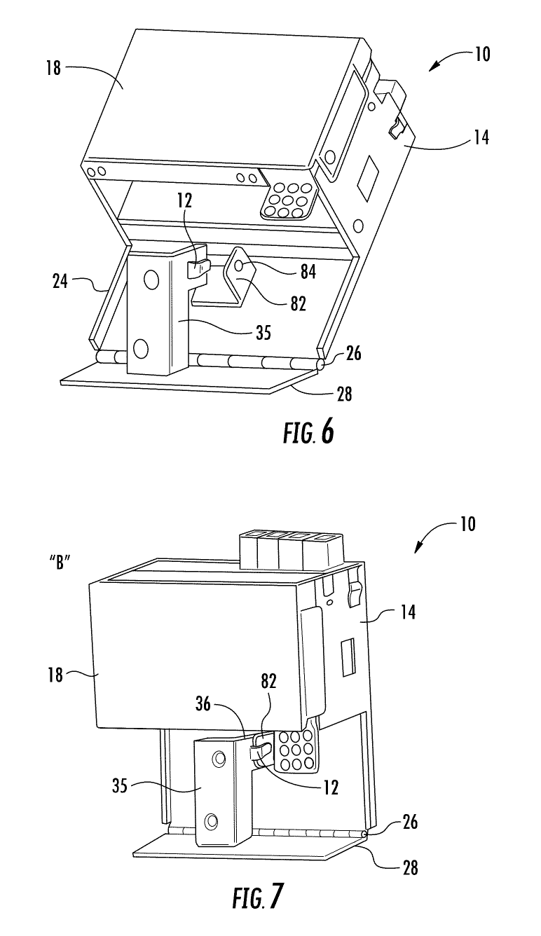

FIG. 6 shows a rear view of the cradle assembly 10 rotated between a unrotated, unengaged position “A” and a rotated, engaged position “B”, or, in other words between and open and closed position. The cradle assembly 10 has a catch flange that contains the snap fastener. It is located such that upon opening and closing of the cradle assembly or rotational access, the cradle assembly 10 will engage the snap fastener 12 and releasably lock in place. In this regard, the cradle 14 has a mating flange 82 a hole 84 that receives the snap fastener 12 on the tab feature 36 to toollessly and releasably retain the cradle 14 in the rotated, engaged position “B”.

FIG. 7 shows a back view of the cradle 14 of the cradle assembly 10 in the rotated, engaged or closed position. In FIG. 7, the snap fastener 12 on the tab feature 36 is fully engaged and mated with the mating flange 82.

The snap fastener 12 provides advantages which include, without limitation, a cost savings due to reduced number of components and assembly of the components required for traditional methods has been eliminated. Additionally, hardware (such as screws, nuts, bolts, etc.) to fasten components to telecom enclosure in traditional methods may not be required, as well as, tools to assemble components. The snap fastener 12 may also function as a spring loaded tab in metal. Further, the snap fastener 12 allows panels and modules or rotational action of the cradle to be installed or removed multiple times while maintaining its function to spring back and forth to releasably lock or attach components in place.

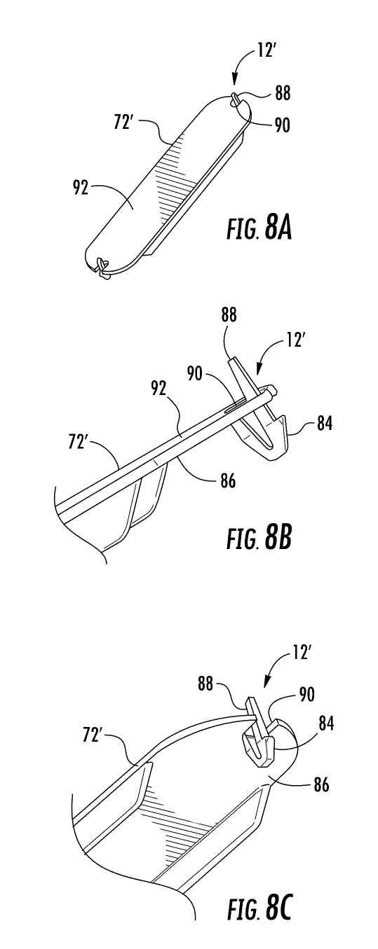

FIGS. 8A, 8B, 8C illustrate an exemplary embodiment of a plastic version of an adapter panel 72′ that has a snap fastener 12′ molded into the adapter panel 72′. Although not shown in FIGS. 8A, 8B, 8C the adapter plate 72′ may have holes extending therethrough in which adapters may be mounted. The snap feature 12′ has a “J” hook 84 attached at one end to the adapter panel 72′ and extending from an inside surface 86 of the adapter panel 72′. An actuator 88 is attached to and extends from the other end of the “J” hook 84 though an opening 90 in the adapter panel 72′ to a distance past the outside surface 92 of the adapter panel 72′. The snap fastener 12′ is resilient in that the “J” hook 84 will toollessly and releasably locate and lock into a receiving hole in an optical component or structure, as non-limiting examples, a housing, enclosure or chassis. Manipulating the actuator 88 will release the “J” hook 84 from the receiving hole allowing the adapter plate 72′ to be removed from the optical component or structure, as non-limiting examples, a housing, enclosure or chassis.

Many modifications and other embodiments not set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A cradle assembly, comprising:
a cradle adapted to receive an optical component such that the optical component toollessly and releasably attaches to the cradle; and
a cradle connection assembly, wherein the cradle connection assembly is adapted to toollessly and releasably attach to a housing.

2. The cradle assembly of claim 1, further comprising a snap fastener.

3. The cradle assembly of claim 2, wherein the snap fastener is used to toollessly and releasably attach the optical component to the cradle.

4. The cradle assembly of claim 2, wherein the snap fastener is used to toollessly and releasably attach the cradle connection assembly to the housing.

5. The cradle assembly of claim 1, wherein the optical component is a module, wherein the module includes fiber optic adapters.

6. The cradle assembly of claim 1, wherein the optical component is an adapter panel, wherein the adapter panel includes fiber optic adapters.

7. The cradle assembly of claim 1, wherein the optical component is a slack box.

8. The cradle assembly of claim 1, further comprising a hinge, wherein the hinge allows the cradle to rotate between an unengaged position and an engaged position.

9. The cradle assembly of claim 8, wherein a snap fastener toollessly and releasably attaches the cradle in the engaged position.

10. The cradle assembly of claim 9, wherein the cradle connection assembly comprises:
a cradle plate; and
a catch flange extending from the cradle plate, wherein the catch flange includes a tab feature, and wherein the snap fastener is mounted to the tab feature.

11. A method for attaching an optical component to a structure:
providing a snap fastener attached to the optical component;
providing an accepting feature attached to the structure; and
moving the optical component such that the snap fastener contacts the accepting feature wherein the accepting feature accepts the snap fastener attaching the optical component to the structure.

12. The method of claim 11, wherein the structure is an enclosure.

13. The method of claim 11, wherein the structure is a housing.

14. The method of claim 11, wherein the structure is a chassis.

15. The method of claim 11, wherein the structure is a cradle.

16. The method of claim 11, wherein the optical component is a module.

17. The method of claim 11, wherein the optical component is an adapter panel.

18. The method of claim 11, wherein the optical component is a slack box.

19. The method of claim 11, wherein the optical component is a cradle and the structure is a housing.

20. An apparatus for attaching an optical component to a structure, comprising:
a snap fastener integrally formed with and part of the optical component; and
an accepting feature attached to the structure, wherein when the snap fastener is brought into contact with the accepting feature, the accepting feature accepts the snap fastener thereby attaching the optical component to the structure.
